(19) United States
(12) Patent Application Publication
(10) Pub. No.: US 2006/0027944 A1
(43) Pub. Date: Feb. 9, 2006

(54) APPARATUS AND METHOD FOR IN-LINE MANUFACTURING OF DISPOSABLE HYGIENIC ABSORBENT PRODUCTS AND PRODUCT PRODUCED BY THE APPARATUS AND METHODS

(76) Inventors: Rachelle Bentley, Cumming, GA (US); Stephen D Bernal, Cincinnati, OH (US); Patrick L Crane, Dawsonville, GA (US)

Correspondence Address: WOOD, HERRON & EVANS, LLP (NORDSON), 2700 CAREW TOWER, 441 VINE STREET, CINCINNATI, OH, 45202, US

(21) Appl. No.: 10/710,865

(22) Filed: Aug. 9, 2004

(51) Int. Cl. B32B 17/00

(52) U.S. Cl. 264/171.1; 156/62.2; 156/244.11; 425/72.2

(57) ABSTRACT

Methods, apparatus and disposable hygienic absorbent products involving melt processing a synthetic resin or resins, such as a thermoplastic, in an in-line process. The melt processing operations can be melt spinning processes such as spunbonding and/or meltblowing the resin(s). One or more through air bonders are used in the process to provide bonding between fibers or filaments while retaining the liquid management properties of the fibers or filaments in the disposable hygienic absorbent product. Other melt processing operations, such as film extrusion, may also be used to form one or more layers in the disposable hygienic absorbent product.

### FIELD OF THE INVENTION

The invention generally relates to apparatus and processes for manufacturing of disposable hygienic absorbent products having multiple layers of melt spun filaments with various fluid management properties. The invention is further directed to products, such as diapers, feminine care products and other disposable hygienic absorbent products.

### BACKGROUND OF THE INVENTION

The equipment used for manufacture of disposable hygienic absorbent products, such as diapers, sanitary napkins, adult incontinent pads and the like, is generally referred to as converter equipment and the process is generally referred to as converting. The converter equipment processes separate rolls of stock material into the products. The converter equipment generally comprises stations for manufacturing the disposable hygienic absorbent products as follows:

(a) An absorbent core forming station comprising a hammermill is fed by pulp roll stock, such as cellulosic material with or without superabsorbent. The hammermill fiberizes the pulp, and a drum form or flat screen then forms the fiberized pulp. Alternatively, the absorbent core material can be supplied in roll form.

(b) A top layer station supplies a top layer or coverstock layer comprising a nonwoven, such as spunbond polypropylene. The top layer is unwound from a roll and applied to the core layer.

(c) A bottom layer station supplies a liquid-impervious backsheet, such as polyethylene film. The bottom layer is unwound from a roll and applied to the top layer/core combination. The bottom layer is adjacent the core to form a top layer/core/bottom layer combination.

A characteristic common to existing converter equipment and processes is that they use only roll stock or material bales to form the layers of the disposable hygienic absorbent product. The roll stocks are separately manufactured into rolls, typically off site, and then transported to the site of use. These rolls are processed by the converter equipment to form the products.

Converter equipment typically comprises a large complex laminating machine which requires significant horizontal and vertical plant space. The complex equipment requires constant loading of material roll goods and often requires fine tuning. Also, converter equipment generally produces a one-line output so the unit output is directly proportional to the line speed. Accordingly, the converter equipment must operate at extremely high speed, such as 700 to 1200 ft./min., to be economical.

As the converter equipment handles only preformed roll stock, it has a serious operational disadvantage. That is, once the multiple rolls are installed, the composition, properties or dimensions of the roll stocks themselves cannot be changed. In order to produce different types of disposable hygienic absorbent products, or disposable hygienic absorbent products of the same type but having different properties, the converter must be shut down and a new roll or rolls substituted for the existing roll or rolls. This may involve scrapping significant inventory of existing roll stocks. Moreover, there is significant lead time involved with obtaining roll stocks from suppliers after a request is made, for example, to change the composition, properties and/or dimensions of the rolls.

U.S. Pat. No. 6,502,615 discloses an in-line process capable of eliminating one or more of the conventional roll stocks for forming various layers of the disposable hygienic absorbent products. The disclosure of U.S. Pat. No. 6,502,615, which is assigned to Nordson Corporation of Westlake, Ohio, is hereby incorporated by reference herein. Despite the improvements set forth in U.S. Pat. No. 6,502,615, additional improvements would be desirable which further assist with producing a commercially viable and economical in-line process and allow optimizing the fluid management properties of each layer in the disposable hygienic absorbent product. In particular, it would be desirable to better maintain the fiber or filament matrix by reducing the area of thermal fusion which occurs throughout the product in the “z” direction (i.e., the heightwise dimension or thickness) with the use of a calendaring process. As shown in FIG. 1, calendaring processes use rolls to compress and bond the fibers or filaments in individual nonwoven layers 2, 4, 6 forming depressions 2a, 4a, 6a which may, for example, be frustoconical in shape. In addition, when the layers 2, 4, 6 are bonded together with a calendaring process, additional depressions 8a are formed in the overall layered composite. Each of the depressions 2a, 4a, 6a, 8a dispersed throughout the resulting composite forms essentially a small liquid impervious area 2b, 4b, 6b, 8b which impedes the transfer of liquid both from layer to layer and within the same layer. Each layer 2, 4, 6, and the overall composite, can typically have 15-20% of its surface area covered with these liquid impervious depressions. The significant impediment of liquid flow caused by areas 2b, 4b, 6b, 8b presents difficulties when designing disposable hygienic absorbent products with the ability to properly manage fluid distribution. For example, this effect of calendaring is typically counteracted by using an increased amount of material to generate sufficient capillary action. The increased material leads to added expense and bulkiness in the product.

It would therefore be desirable to address such drawbacks in an in-line process for manufacturing a disposable hygienic absorbent product.

### SUMMARY OF INVENTION

The method and apparatus of the present invention involve melt processing a synthetic resin or resins, such as a thermoplastic, in an in-line process to form a disposable hygienic absorbent product. The melt processing can include extruding films, or melt spinning filaments such as spunbonding and/or meltblowing.

In one embodiment, an in-line system for forming a disposable hygienic absorbent product includes a bottom layer forming station, a core forming station, an acquisition layer forming station, and a top layer forming station. Each of these stations include at least one melt spinning apparatus including at least one die configured to discharge a layer of filaments or fibers. The terms filament and fiber are used interchangeably herein. The melt spinning die of the bottom layer forming station discharges a first layer of filaments for forming a substantially liquid impermeable bottom layer. The bottom layer may comprise more than one layer or sheet such as an outermost sheet which is soft to the touch and an inner barrier sheet which supplies additional liquid barrier properties, in which case a separate melt spinning die will be provided for each layer or sheet. The station provided for this configuration may be a single station with multiple dies or multiple stations may be used instead. The core forming station comprises a second melt spinning apparatus including a die configured to discharge a second layer of filaments for forming an absorbent core layer. The acquisition layer forming station includes a third melt spinning apparatus including a die configured to discharge a third layer of filaments for forming a fluid acquisition layer. The top layer forming station includes a fourth melt spinning apparatus including a die configured to discharge a fourth layer of filaments for forming a liquid permeable top layer. The term “through air bonder” is intended to mean any bonder that

1. directs energy towards the filaments causing at least a portion of some of the filaments to sufficiently tackify as to form a physical bond;

2. draws air through the layers while at least a portion of some of the filaments are tacky creating pressure on the filaments and controlling the loft or z-direction length of the layers; and

3. prevents the liquid impervious depressions caused by calendaring and illustrated in FIG. 1.

In the preferred embodiment the energy is directed towards the filaments by heating the drawing air. One skilled in the art would appreciate that heat and/or other forms of energy could be used in steps separated in time from the drawing of air or simultaneously therewith. Energy forms other than heat include, but are not limited to, infrared, ultraviolet, radio frequency, microwave or combinations thereof. A through air bonder is positioned downstream from the various stations and is configured to receive and thermally bond together the filaments comprising at least the bottom layer, core layer, acquisition layer, and top layer. A through air bonder, used in this manner, overcomes the problems associated with calendaring the various layers and provides filament-to-filament bonding while retaining and optimizing fluid management properties within the layers by more effectively using capillary action.

In another embodiment of the in-line system according to this invention, the system includes a bottom layer forming station, core forming station, acquisition layer forming station and top layer forming station as in the first embodiment. However, a first through air bonding station is positioned to receive and thermally bond together the filaments comprising the bottom layer. A second through air bonding station is positioned to receive and thermally bond together the core layer, acquisition layer, and top layer into a composite structure. Another melt processing station, which may be a film extruder or another one or more melt spinning dies, is positioned downstream of the bottom layer station to form a liquid barrier layer. In the case of using one or more additional melt spinning dies for the barrier layer, another through air bonder may be used to bond together the bottom layer, barrier layer and the composite structure. In the case of using an extruder to produce a film barrier layer, or if the melt spun barrier layer does not allow sufficient air flow to use a through air bonder, adhesive applicators are preferably used to bond the film layer to the melt spun bottom layer and to the composite structure.

The in-line system preferably includes first and second core containment layer forming stations respectively having fifth and sixth melt spinning apparatus including respective dies configured to discharge fifth and sixth layers of filaments for forming respective first and second core containment layers for sandwiching the core layer therebetween. In this regard, the core layer can contain a superabsorbent material, which may be sprayed or otherwise applied to the core layer filaments. The core containment layers are designed to contain the superabsorbent in the core layer. The melt spinning dies may comprise spunbond dies and/or meltblown dies depending on the desired makeup of the various layers. For example, the bottom layer may comprise one spunbond layer and one meltblown layer, whereas the acquisition, core and top layers may each comprise spunbond filaments. Further, the melt spinning dies preferably comprise multicomponent filament producing dies, such as bicomponent dies, or dies for producing a mixture of monofilaments formed of different synthetic resinous thermoplastic materials. Each multicomponent filament includes one or more sections of a relatively low melt temperature synthetic resin and one or more sections of a relatively high melt temperature synthetic resin. The low melt temperature resin is exposed so as to bond with other exposed low melt resinous portions of the same filament and/or other filaments. The filaments may also or alternatively be monofilaments with some of the monofilaments formed of a relatively low melt temperature resin and some of the monofilaments formed from a relatively higher melt temperature resin. Alternatively, the filaments of one or more layers may be monofilaments of different thermoplastic materials having different melt temperatures, as described herein, and the filaments of one or more other layers may be multi-component filaments as described herein. In fact, each station of a system constructed in accordance with the invention may comprise multiple monofilament and/or multicomponent filament producing dies. In each case, the high melt temperature synthetic resin remains structurally sound, i.e., in tact as filaments, during and after the through air bonding process step, whereas the low melt temperature resin at least partially melts (i.e., sufficiently softens or tackifies) to adhere with intersecting filaments or fibers.

The invention further contemplates methods of in-line manufacture of disposable hygienic absorbent products generally involving the processes used in the apparatus described above, and also products produced in accordance with the inventive methods and using the apparatus of this invention.

One significant advantage to this invention, especially over prior art calendaring based processes is that fluid impervious areas are minimized or eliminated in those areas in which it is necessary to manage fluid transfer via capillary action. The loft of the resulting product is better controlled since significant compression of each layer does not take place. Moreover, since bonds are established filament-to-filament, characteristics such as capillary action, void volume and fluid distribution speed are more effectively controlled and optimized in the final product.

Various additional features, advantages and objectives of the invention will become more readily apparent to those of ordinary skill in the art upon review of the following detailed description of the preferred embodiments taken in conjunction with the accompanying drawings.

### BRIEF DESCRIPTION OF DRAWINGS

FIG. 1 is a schematic cross sectional view of a conventional layered composite nonwoven formed using calendaring operations.

FIG. 2 is a schematic illustration of a first in-line manufacturing apparatus in accordance with the invention.

FIGS. 3A and 3B are schematic cross sectional illustrations of a first disposable hygienic absorbent product, respectively taken along lines 3A-3A and 3B-3B of FIG. 2, and respectively illustrating prebonding and postbonding stages of the product.

FIG. 3C is a perspective view showing intersecting monofilaments respectively formed of different materials prior to a bonding process.

FIG. 3D is a perspective view of the intersecting filaments of FIG. 3C bonded together after a through air bonding process.

FIG. 3E is a perspective view showing intersecting bicomponent filaments prior to a bonding process.

FIG. 3F is a perspective view of the intersecting bicomponent filaments of FIG. 3E bonded together after a through air bonding process.

FIG. 4 is a schematic illustration of a second in-line manufacturing apparatus constructed in accordance with the invention.

FIGS. 5A and 5B are schematic cross sectional illustrations of a second disposable hygienic absorbent product produced with the apparatus of FIG. 4 and respectively illustrating prebonding and postbonding stages of the product.

FIG. 6 is a schematic illustration of a third in-line manufacturing apparatus constructed in accordance with the invention.

FIG. 7 is a cross sectional view diagrammatically illustrating a through air bonder which may be used in any of the embodiments of the invention.

FIG. 8 is a perspective view of an alternative drum usable with through air bonders in carrying out the invention and its various embodiments.

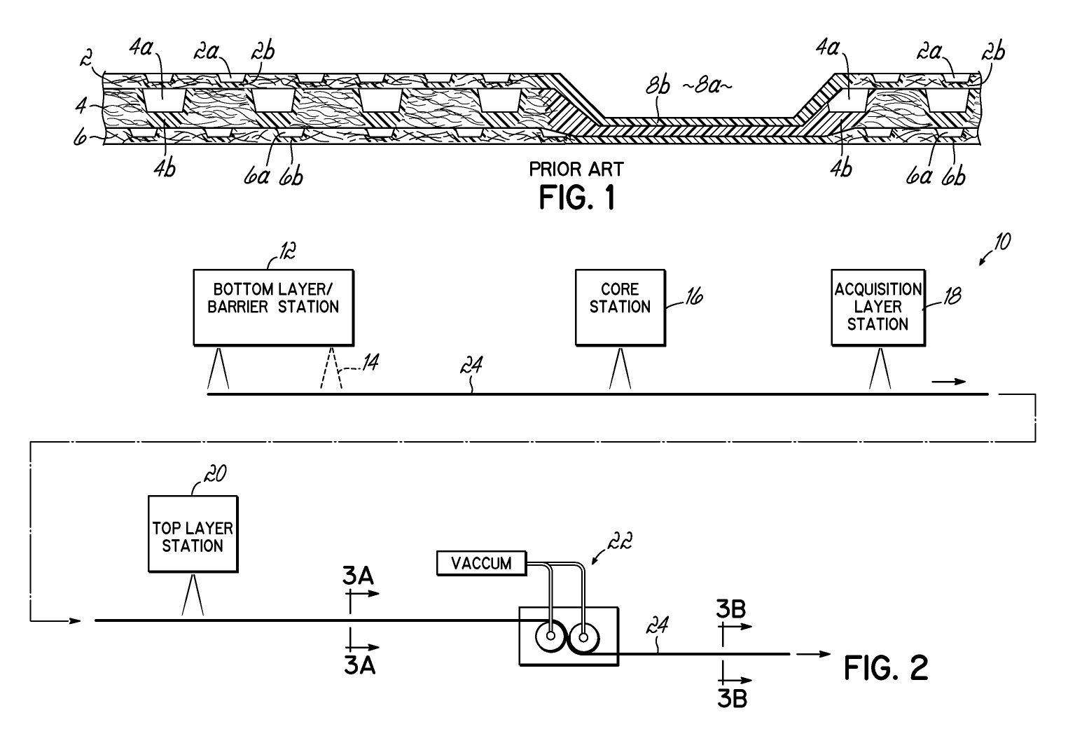

### DETAILED DESCRIPTION

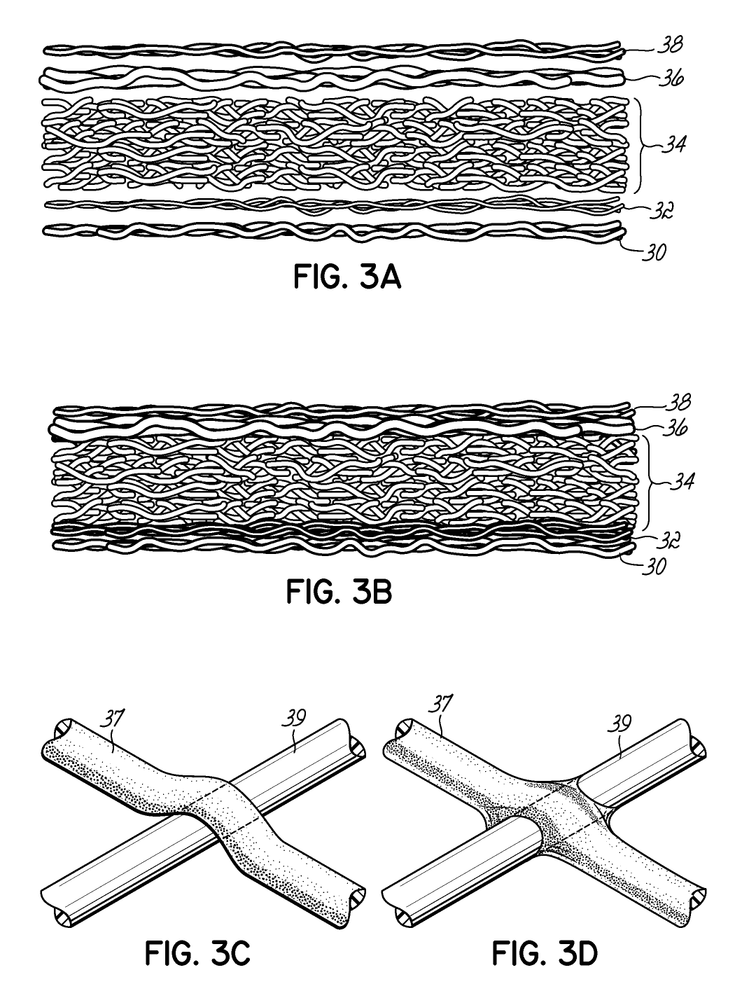

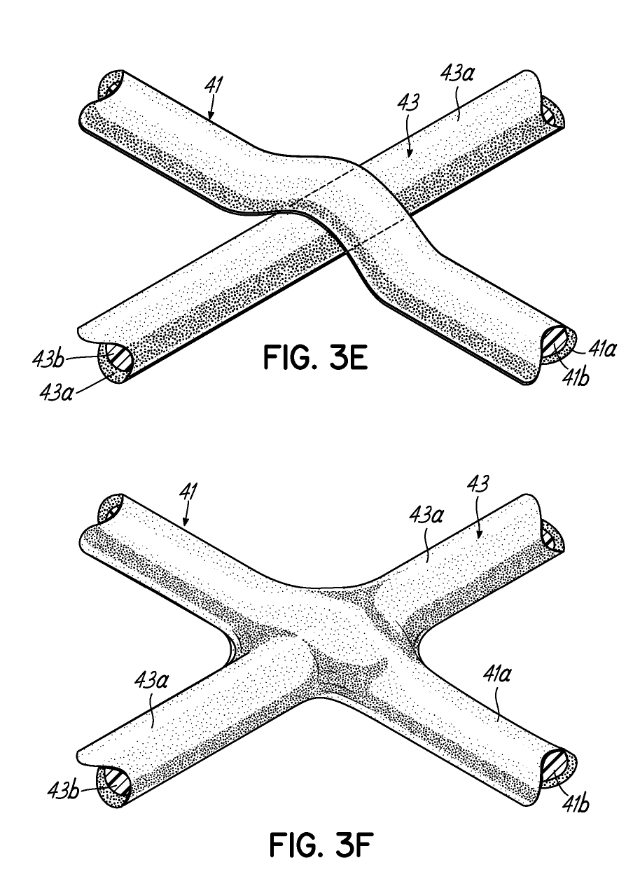

FIG. 2 schematically illustrates an in-line manufacturing apparatus or system 10 comprised of a bottom layer station 12 which can optionally have an additional die for discharging barrier filaments 14, a core station 16, an acquisition layer station 18, and a top layer station 20. At the end of the inline process, a through air bonder 22 receives the multi-layer composite, as shown in FIG. 3A, and bonds the various layers together as shown in FIG. 3B. The layers shown in FIG. 3A are separated for clarity, however, in practice, these layers will rest one on top of the other based on the order of deposition of the various layers during the in-line process. Each station 12, 16, 18, 20 comprises at least one melt spinning apparatus, such as one or more spunbonding units and/or one or more meltblown units for directly depositing filaments onto a moving collector or conveyor 24. Preferably, each of these stations deposits multi-component filaments, monofilaments, or combinations thereof to form the multi-layer composite shown, by way of example, in FIG. 3B comprising a bottom layer 30, a barrier layer 32 which may be formed as part of the bottom layer 30, a core layer 34, an acquisition layer 36, and a top layer 38. The filaments may, for example, be formed from a sheath-core construction in which the core is formed from polypropylene and the sheath is formed from polyethylene. Other types of multi-component cross-sectional configurations and different types of materials may be used depending on the application needs. As discussed below, another option is to use monofilaments formed respectively from different materials. Certain layers, such as the barrier layer 32 formed at station 14, may comprise monofilaments of a single relatively high melt temperature material such that no more than an insubstantial amount of thermal bonding between filaments will take place during the manufacturing process. This is due to the fact that such layers will not need structural integrity (i.e., the ability to resist shear between filaments of that layer or with filaments of adjacent layers).

Each layer 34, 36, 38 manages fluid by transferring liquid through capillary structures while layers 30 and 32 are preferably breathable (i.e., allow moisture vapor transmission) but are not liquid permeable. For example, the top layer 38 acquires the liquid and creates a comfortable, dry surface against the skin. The acquisition layer 36 moves the liquid in the z-direction (that is, through the thickness of the product perpendicular to the top layer 38) and disperses the liquid in x-y directions generally perpendicular to the z-direction. The absorbent or core layer 34 retains the liquid and may include various fibrous or non-fibrous materials which are not melt spun (i.e., non-fiberized) for assisting with liquid retention including, but not limited to, superabsorbent materials. To assist with retaining superabsorbent material in the core layer 34, for example, a multi-layer construction may be used with one or both outermost layers 30, 38 having a larger area which will drape over the sides of the core layer 34. In addition these outermost layers 30, 38 may be formed of finer denier filaments than the central core layer 34 to reduce migration of any superabsorbent material from the core layer 34. The bottom layer 30 can provide a barrier against unwanted egress of liquid from the multi-layer construction. That is, the bottom layer 30 could be formed in a substantially liquid impervious such that it withstands at least 700 mm of water column height. In other embodiments, one or more additional liquid barrier layers 32 may be combined with the bottom layer 30. The amount of liquid barrier protection may depend on the application needs. For example, while a diaper may need to withstand 700 mm of water column height, a feminine care product may need less barrier capability.

Preferably, the top layer 38 is comprised of filaments at about 2-3 denier per filament (dpf). The acquisition layer 36 is comprised of filaments of about 5.0-9.0 dpf. The absorbent core layer 34 is comprised of filaments in the range of about 1.3-9 dpf. Fibers in the barrier layer 32 are preferably melt blown and have a diameter in the range of about 1.0-2.0 microns. The filaments comprising the bottom layer 30 are in the range of about 1.3-2.0 dpf. It will be understood that the order of the various stations/dies may be changed and stations/dies added based on the needs of the product being manufactured.

FIGS. 3C and 3D schematically illustrate the filament-to-filament bonding that occurs when using a through air bonder and separate monofilaments formed of materials having different melt temperatures. For example, polyethylene filaments 37 may be used in conjunction with polypropylene filaments 39. Upon heating the filaments 37, 39 to a temperature sufficient to slightly melt the polyethylene filaments 37 but still well below the melt temperature of the polypropylene filaments 39, the polyethylene filaments 37 bond to the polyethylene filaments as shown in FIG. 3D. Polyethylene filaments 37 also bond to other intersecting polyethylene filaments. The polypropylene filaments 39 remain intact and structurally sound.

FIGS. 3E and 3F schematically illustrate the filament to filament bonding that occurs when using a through air bonder and multi-component filaments, such as bicomponent filaments each formed of materials having different melt temperatures. For example, filaments 41, 43 may be constructed with a sheath-core configuration having a polyethylene sheath 41a, 43a surrounding a polypropylene core 41b, 43b. Other multi-component types of filaments may be used as long as the relatively lower temperature component is at least partially exposed upon melting or partially melting so as to enable bonding to take place. Upon heating the filaments 41, 43 in a through air bonder to a temperature sufficient to slightly melt the polyethylene sheaths 41a, 43a but still well below the melt temperature of the polypropylene cores 41b, 43b, the polyethylene sheaths 41a, 43a bond to each other as shown in FIG. 3F. The polypropylene cores 41b, 43b remain intact and structurally sound.

For example, the through air bonder 22 is configured to heat the filaments to approximately 270° while drawing heated air through the multi-layer composite at a rate of between about 50 cfm and 500 cfm. The temperature and air flow rate will change, for example, depending on various parameters such as dwell time in the through air bonder, surface area of the drums used in the through air bonder, filament material and denier, layer thickness or loft, etc. Following the through air bonding process, the multi-layer composite product may be further processed, such as through slitting operations and other manufacturing operations in accordance with the product to be produced, such as described in the above-incorporated U.S. Pat. No. 6,502,615.

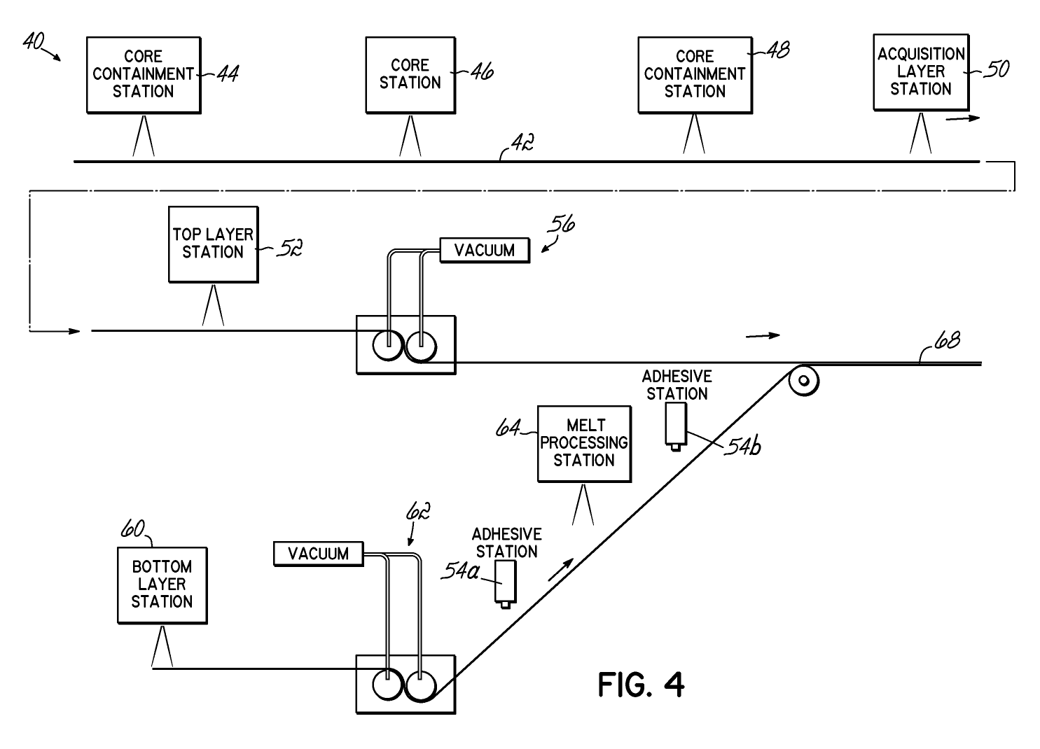

FIG. 4 illustrates another embodiment of the invention involving an in-line process. In this apparatus 40, multiple melt spinning stations are provided along a moving collector or conveyor 42, including a core containment station 44, core station 46, core containment station 48, acquisition layer station 50, and top layer station 52. Like the first embodiment, each of the melt spinning stations 44, 46, 48, 50, 52 may be one or more spunbonding units and/or meltblowing units. A through air bonder 56 is provided downstream of the top layer station 52 for thermally bonding filaments of the top layer, acquisition layer, core layer, and the two core containment layers on opposite sides of the core layer together, as described below and generally described in connection with FIGS. 3C-3F. A separate bottom layer forming station 60 is provided with a through air bonder 62 downstream thereof. A barrier film may optionally be extruded onto the bottom layer at a melt processing station 64 or, as with the first embodiment, barrier fibers or filaments may be laid down in-line instead. Thus, the term melt processing encompasses various melt processes, including but not limited to, extrusion of films and melt spinning of filaments. If a single layer of bottom layer and/or barrier fibers is not sufficient to achieve fluid imperviousness, then multiple layers may be used. Adhesive may be applied as shown from respective stations 54a, 54b to adhere the barrier film to the bottom layer and to the composite structure exiting the through air bonder 56. Other bonding methods aside from adhesive may be used. For example, the layer formed at station 64 may adhere directly to one or both adjoining layers without any adhesive. The final composite product 68 may be passed through a third through air bonder (not shown) when barrier fibers or filaments are laid down at station 64 instead of a film. In this case, adhesive stations 54a, 54b may be eliminated.

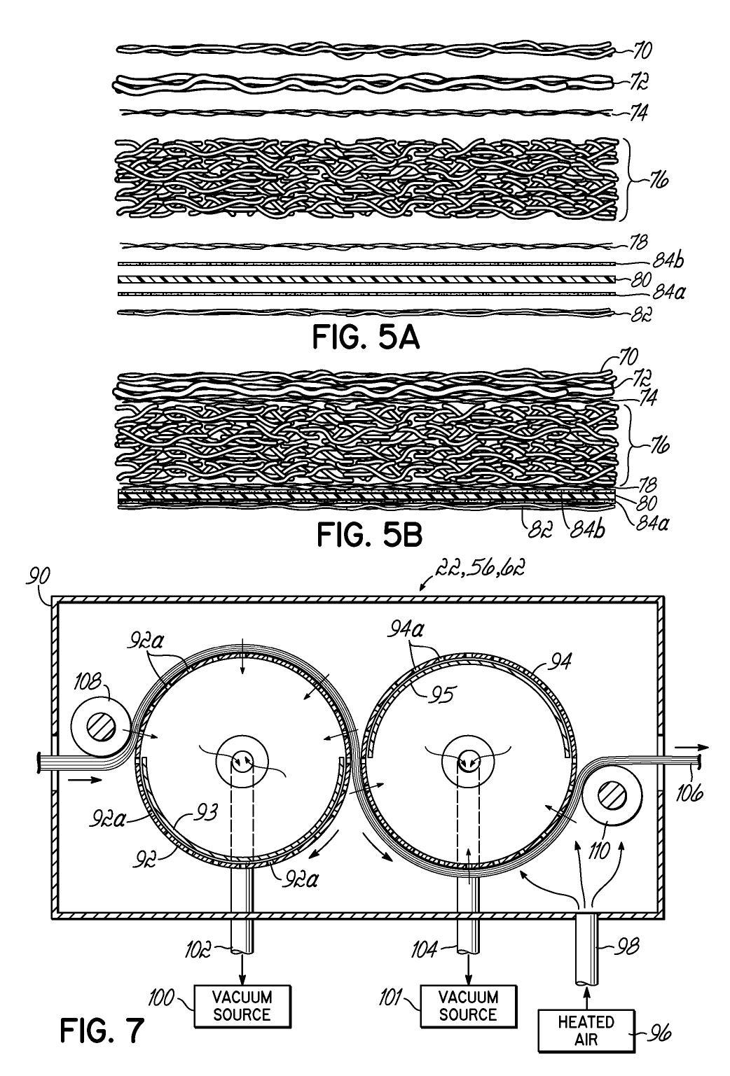

FIGS. 5A and 5B illustrate the resulting multi-layer disposable hygienic absorbent product construction formed completely from in-line extrusion processes including a top layer 70, acquisition layer 72, core containment layer 74, core layer 76, core containment layer 78, liquid impervious film layer 80, bottom layer 82, and adhesive layers 84a, 84b. The various deniers of the filaments comprising the layers are as described above with respect to the first embodiment, with the additional core containment layers 74, 78 being formed from filaments having deniers in the range of about 1.5-2.0 dpf.

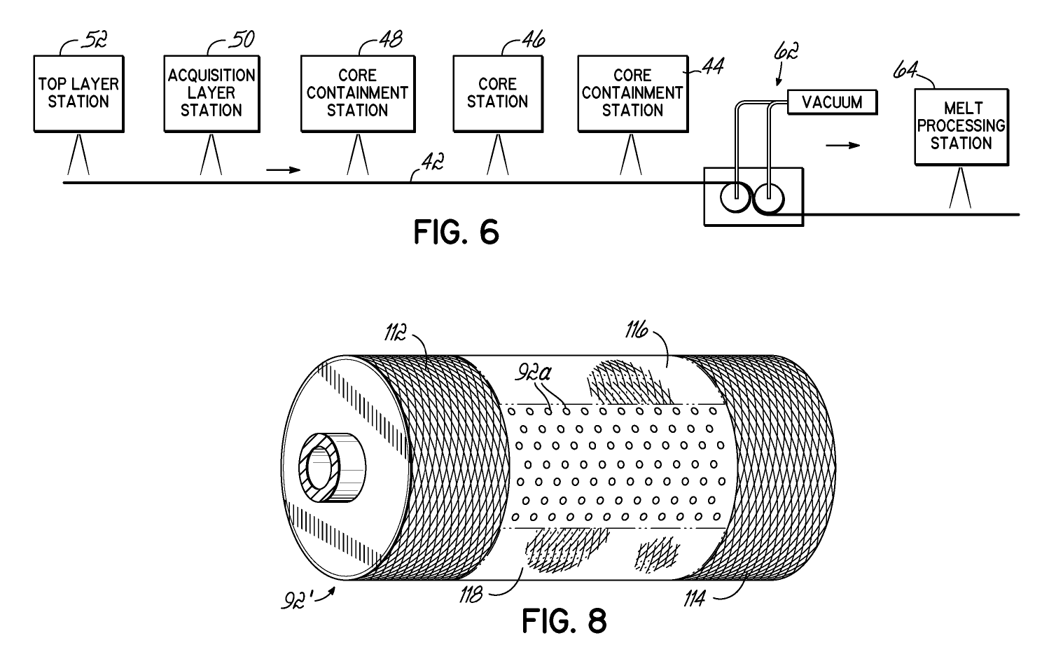

FIG. 6 schematically illustrates another in-line apparatus which reverses the positions of the various stations. In this regard, the top layer station 52 lays down one or more layers onto a collector or conveyor 42. The acquisition layer station 50, core containment station 48, core station 46 and core containment station 44 are respectively downstream of top layer station 52 to consecutively lay down additional filament layers comprising the fluid acquisition layer, core layer and core containment layers above and below the core layer. The composite filament layered structure formed by the stations is directed through a through air bonder 62. Downstream of through air bonder 62, which bonds the filaments of the composite structure together as previously discussed, a melt processing station forms a fluid impervious bottom layer or backsheet on the composite structure to form the disposable hygienic absorbent product. As this is downstream of the through air bonder, this melt processing station may, for example, simply extrude a film layer onto the composite structure which exits through air bonder 62 to complete the formation of the disposable hygienic absorbent product. As with the other disposable hygienic absorbent products formed in accordance with the present invention, the products which exit the in-line apparatus disclosed and illustrated herein may be subjected to other processes, such as slitting and bonding processes and other operations for adding accessory items depending on the product needs. It will also be understood that the various layers may be laid down in different orders depending on the needs of the product and that an in-line process and apparatus constructed according to the invention may include a single conveyor or collector as illustrated herein in FIGS. 2 and 6, or a line which has one or more portions which come in tangentially, such as shown in FIG. 4.

FIG. 7 schematically illustrates, in cross section, a through air bonder (22, 56, 62) of the type used in the previously described embodiments, although it will be understood that various types of through air bonders may be used in connection with the invention. The through air bonder (22, 56, 62) includes a housing 90 having at least one cylindrical drum mounted in its interior (although a pair of cylindrical drums 92, 94 is shown). For example, drums 92, 94 are closely spaced and rotate about parallel axes. The air in the interior of the housing is heated, such as by providing a source 96 of heated air which is directed into the housing 90 through one or more conduits 98. Respective vacuum sources 100, 101 draw air into drums 92, 94 through perforations 92a, 94a in the outer surfaces thereof, and through respective conduits 102, 104. Vacuum sources 100, 101 may be set to different vacuum levels if, for example, it is desirable to have different air flow rates and, therefore, different amounts of compressive force applied to different sides of composite 106. This concept also applies to the other embodiments of the invention. For example, it may be desirable to apply more compressive force to a bottom layer or backsheet of composite 106 to help facilitate its fluid impermeability. Other manners of regulating the air flow rate into drums 92, 94 and through composite 106 may be used as well. It will be appreciated that various air moving devices, using positive or negative air pressure, may be used to carry out the invention.

The nonwoven composite 106, comprised of one or more layers of extruded filaments, is directed between respective rollers 108, 110 and the pair of drums 92, 94 as shown. A pair of dampers 93, 95 are positioned in the respective drums 92, 94 to ensure that air drawn into the drums 92, 94 is drawn mainly through composite 106. As the composite 106 passes over the drums 92, 94, heated air 96 is drawn past the filaments comprising the composite 106 and thereby heats and bonds the filaments as previously described. It will be appreciated that other forms of through air bonders may be used to carry out the present invention with each being generally configured to direct heated air through the composite 106 in either direction to achieve the necessary amount of filament bonding. Such air movement may be carried out in negative or positive pressure systems.

Different air flow rates or pressure and/or different amounts of heat or other energy directed at different portions of the nonwoven composite 106 to facilitate the development of desired characteristics in the resulting product. For example, air may be drawn through one side of the composite at a different rate in drum 92 than in drum 94 which draws air through an opposite side of the composite 106. This results in different densities on opposite sides of the composite 106. Likewise, the through air bonder may be configured to vary the temperature of the heated air or, more generally speaking, the amount of energy depending on the desired characteristics of composite 106. Increasing the heat, for example, can affect the crystalline structure of the polymers making up the filaments causing increased filament curl and, therefore, increased loft in the composite 106. Increasing and decreasing the heat can also correspondingly increase and decrease the bonding points or bonding areas between filaments.

In general, the use of a through air bonder in accordance with the present invention directs more uniform force against each filament during the filament-to-filament bonding process than direct physical compression as in the case of using conventional calendar rolls. In the case of calendar rolls, compression will tend to focus on the outer layers which are in direct contact with the rolls. In addition, calendaring does not allow the selective adjustment of product characteristics, such as bulk density variance, as with the present invention.

FIG. 8 illustrates a modified drum 92′ which may be used in a through air bonder in accordance with principles and embodiments of the present invention. As with drum 92, drum 92′ includes perforations 92a by which air is drawn through a composite 106 (FIG. 7) into drum 92′ generally as previously described with respect to drum 92. The modification shown in FIG. 8 involves the addition of one or more mesh areas 112, 114, 116, 118. These mesh areas impede the flow of air into drum 92′ at selected areas and by a desired amount depending on the density of the mesh material. Therefore, the air flow forces on the filaments in the composite 106 are less in those areas of the composite 106 which move directly over the areas of drum 92′ covered by the mesh material 112, 114, 116, 118. In these areas which experience lower compressive force, the composite 106 will have greater loft (i.e., less density) than those areas of the composite 106 which travel directly over exposed perforations 92a with greater air flow. Such density variations may be achieved in the machine direction using spaced apart mesh areas 116, 118, or other manners of restricting the air flow such as smaller perforations 92a, and also in the cross machine direction using mesh areas 112, 114, or other manners of air flow restriction, extending entirely around the circumference of drum 92′. Alternatively, and although not shown, areas 112, 114 shown to be covered by mesh may be left as perforations 92a, while the entire middle section of drum 92′ may be covered with a mesh material, or incorporate other manners of air restriction, such that the central area of the composite 106 is more lofted than the outer edges of the composite 106 (FIG. 7). It will be appreciated that many other variations may be utilized by those of ordinary skill depending on the loft characteristics desired for the product being produced.

While the present invention has been illustrated by a description of various preferred embodiments and while these embodiments has been described in some detail, it is not the intention of the Applicants to restrict or in any way limit the scope of the appended claims to such detail. Additional advantages and modifications will readily appear to those skilled in the art. The various features of the invention may be used alone or in numerous combinations depending on the needs and preferences of the user. This has been a description of the present invention, along with the preferred methods of practicing the present invention as currently known.

What is claimed is:

1. An in-line system for forming a disposable hygienic absorbent product, comprising:
a bottom layer forming station having a first melt spinning die configured to discharge a first layer of filaments for forming a substantially liquid impermeable bottom layer;
a core forming station having a second melt spinning die configured to discharge a second layer of filaments for forming an absorbent core layer;
an acquisition layer forming station having a third melt spinning die configured to discharge a third layer of filaments for forming a fluid acquisition layer;
a top layer forming station having a fourth melt spinning die configured to discharge a fourth layer of filaments for forming a liquid permeable top layer;
said bottom layer forming station, core forming station, acquisition layer forming station, and top layer forming station arranged in-line to produce a layered construction comprising the bottom layer and top layer as outer layers and the absorbent core layer and fluid acquisition layer as inner layers positioned between the outer layers; and
a through air bonder configured to receive and thermally bond together the filaments comprising the bottom layer, core layer, acquisition layer, and top layer to form the disposable hygienic absorbent product.

2. The in-line system of claim 1, further comprising:
a first core containment layer station having a fifth melt spinning die configured to discharge a fifth layer of filaments for forming a first core containment layer;
a second core containment layer forming station having a sixth melt spinning die configured to discharge a sixth layer of filaments for forming a second core containment layer;
said first and second core containment layer stations arranged in-line with said core forming station to discharge the fifth and sixth layers of filaments on opposite sides of the absorbent core layer.

3. The in-line system of claim 1, further comprising:
a barrier layer forming station having a fifth melt spinning die configured to discharge a fifth layer of filaments between the bottom layer and the absorbent core layer to form a fluid barrier.

4. The in-line system of claim 1, wherein said first, second, third and fourth melt spinning dies further comprise multi-component filament spinning dies.

5. The in-line system of claim 1, wherein said first, second, third and fourth melt spinning dies each further comprise dies configured to simultaneously discharge monofilaments of different thermoplastic materials having different melt temperatures.

6. The in-line system of claim 1, wherein at least one of said first, second, third and fourth melt spinning dies further comprises a multi-component filament spinning die, and at least one of said first, second, third and fourth melt spinning dies further comprises a die configured to simultaneously discharge monofilaments of different thermoplastic materials having different melt temperatures.

7. The in-line system of claim 1, wherein said through air bonder further comprises:
first and second independently adjustable air moving devices configured to direct air through the layered construction in opposite directions.

8. The in-line system of claim 1, wherein said through air bonder is configured to direct air through the layered construction at different rates along the length of the layered construction.

9. The in-line system of claim 1, wherein said through air bonder is configured to direct air through the layered construction at different rates along the width of the layered construction.

10. An in-line system for forming a disposable hygienic absorbent product, comprising:
a bottom layer forming station having a first melt spinning die configured to discharge a first layer of filaments for forming a substantially liquid impermeable bottom layer;
a first through air bonder configured to receive and thermally bond together the filaments comprising the bottom layer;
a core forming station having a second melt spinning die configured to discharge a second layer of filaments for forming an absorbent core layer;
an acquisition layer forming station having a third melt spinning die configured to discharge a third layer of filaments for forming a fluid acquisition layer;
a top layer forming station having a fourth melt spinning die configured to discharge a fourth layer of filaments for forming a liquid permeable top layer;
said core forming station, acquisition layer forming station, and top layer forming station arranged in-line to produce a layered construction comprising the fluid acquisition layer positioned between the absorbent core layer and the top layer;
a second through air bonder configured to receive and thermally bond together the core layer, acquisition layer, and top layer into a composite structure, and
a third bonding station configured to receive and bond together the bottom layer and the composite structure.

11. The in-line system of claim 10, further comprising a melt processing station positioned downstream of said first through air bonder and configured to discharge a liquid barrier layer to form part of the bottom layer.

12. The in-line system of claim 11, wherein said third bonding station comprises at least one adhesive dispenser configured to discharge adhesive onto the liquid barrier layer to bond the liquid barrier layer to the composite structure.

13. The in-line system of claim 10, wherein said melt processing station further comprises a film extruder.

14. The in-line system of claim 10, wherein said first, second, third and fourth melt spinning dies further comprise multi-component filament spinning dies.

15. The in-line system of claim 10, wherein said first, second, third and fourth melt spinning dies each further comprise dies configured to simultaneously discharge monofilaments of different thermoplastic materials having different melt temperatures.

16. The in-line system of claim 10, wherein at least one of said first, second, third and fourth melt spinning dies further comprises a multi-component filament spinning die, and at least one of said first, second, third and fourth melt spinning dies further comprises a die configured to simultaneously discharge monofilaments of different thermoplastic materials having different melt temperatures.

17. The in-line system of claim 10, wherein at least one of said first and second through air bonders further comprises:
first and second independently adjustable air moving devices.

18. The in-line system of claim 10, wherein said at least one through air bonder is configured to direct air through a corresponding one of the bottom layer or composite structure at different rates along the length thereof.

19. The in-line system of claim 10, wherein said at least one through air bonder is configured to direct air through a corresponding one of the bottom layer or composite structure at different rates along the width thereof.

20. A method of in-line manufacturing a disposable hygienic absorbent product, comprising:
melt spinning at least a first layer of filaments onto a collector to form a substantially liquid impermeable bottom layer;
melt spinning at least a second layer of filaments to form an absorbent core layer;
melt spinning at least a third layer of filaments to form a fluid acquisition layer;
melt spinning at least a fourth layer of filaments to form a liquid permeable top layer;
applying energy to at least some of the filaments in each layer sufficient to tackify the filaments; and
bonding the filaments in each layer together by directing air through each of the bottom layer, core layer, fluid acquisition layer, and top layer.

21. The method of claim 20, further comprising:
melt spinning at least a fifth layer of filaments to form a first core containment layer;
melt spinning at least a sixth layer of filaments to form a second core containment layer; and
encasing the absorbent core layer between the fifth and sixth layers prior to bonding the filaments in each layer together.

22. The method of claim 20, wherein the melt spinning steps each further comprise melt spinning at least two different thermoplastic materials having different melt temperatures with the relatively lower melt temperature material exposed, and the step of applying energy to the filaments further comprises:
heating the relatively lower melt temperature material to a temperature sufficient to tackify and bond with other intersecting filaments while maintaining the temperature of the relatively higher melt temperature material below its melt temperature.

23. The method of claim 20, wherein the melt spinning steps each further comprise melt spinning at least two different thermoplastic materials having different melt temperatures as multi-component filaments with the relatively lower melt temperature material exposed, and the step of applying energy to the filaments further comprises:
heating the relatively lower melt temperature material to a temperature sufficient to tackify and bond with other intersecting filaments while maintaining the temperature of the relatively higher melt temperature material below its melt temperature.

24. The method of claim 20, wherein the melt spinning steps each further comprise melt spinning at least two different thermoplastic materials having different melt temperatures as monofilaments with a portion of the monofilaments formed from the relatively lower melt temperature material and another portion of the monofilaments formed from the relatively higher melt temperature material, and the step of applying energy to the filaments further comprises:
heating the relatively lower melt temperature material to a temperature sufficient to tackify and bond with other intersecting filaments while maintaining the temperature of the relatively higher melt temperature material below its melt temperature.

25. The method of claim 20, wherein the step of bonding the filaments further comprises:
directing air at a first rate and in a first direction through the bottom layer, core layer, fluid acquisition layer and top layer; and
directing air at a second rate and in a second direction opposite to said first direction through the bottom layer, core layer, fluid acquisition layer and top layer.

26. The method of claim 25, wherein the first and second rates are different.

27. The method of claim 20, wherein the step of bonding the filaments further comprises:
directing air through the bottom layer, core layer, fluid acquisition layer and top layer at different rates along the lengths thereof.

28. The method of claim 20, wherein the step of bonding the filaments further comprises:
directing air through the bottom layer, core layer, fluid acquisition layer and top layer at different rates along the widths thereof.

29. The method of claim 20, further comprising:
adding a non-fiberized absorbent material to said core layer.

30. A method of in-line manufacturing a disposable hygienic absorbent product, comprising:
melt spinning at least a first layer of filaments onto a collector to form a substantially liquid impermeable bottom layer;
applying energy to at least a first portion of the filaments in the first layer sufficient to tackify the first portion of filaments;
drawing air through the bottom layer to bond at least the first portion of filaments together;
melt spinning at least a second layer of filaments to form an absorbent core layer;
melt spinning at least a third layer of filaments to form a fluid acquisition layer;
melt spinning at least a fourth layer of filaments to form a liquid permeable top layer;
applying energy to at least a second portion of the filaments in the second, third and fourth layers sufficient to tackify the second portion of filaments;
drawing air through the core layer, fluid acquisition layer, and top layer to bond the filaments of the core layer, fluid acquisition layer, and the top layer together into a composite structure; and
bonding the bottom layer to the composite structure.

31. The method of claim 30, wherein the melt spinning steps each further comprise melt spinning at least two different thermoplastic materials having different melt temperatures with the relatively lower melt temperature material exposed, and the steps of applying energy each further comprises:
heating the relatively lower melt temperature material to a temperature sufficient to tackify and bond with other intersecting filaments while maintaining the temperature of the relatively higher melt temperature material below its melt temperature.

32. The method of claim 30, wherein the melt spinning steps each further comprise melt spinning at least two different thermoplastic materials having different melt temperatures as multi-component filaments with the relatively lower melt temperature material exposed, and the steps of applying energy each further comprises:
heating the relatively lower melt temperature material to a temperature sufficient to tackify and bond with other intersecting filaments while maintaining the temperature of the relatively higher melt temperature material below its melt temperature.

33. The method of claim 30, wherein the melt spinning steps each further comprise melt spinning at least two different thermoplastic materials having different melt temperatures as monofilaments with a portion of the monofilaments formed from the relatively lower melt temperature material and another portion of the monofilaments formed from the relatively higher melt temperature material, and the steps of applying energy each further comprises:
heating the relatively lower melt temperature material to a temperature sufficient to tackify and bond with other intersecting filaments while maintaining the temperature of the relatively higher melt temperature material below its melt temperature.

34. The method of claim 30, further comprising:
extruding a fluid impermeable film onto the bottom layer.
